(19) United States
(12) Patent Application Publication
(10) Pub. No.: US 2026/0228941 A1
(43) Pub. Date: Aug. 6, 2026

(54) IMAGE PROCESSING SYSTEM, IMAGE REPLACING METHOD AND NON-TRANSIENT COMPUTER READABLE STORAGE MEDIUM

(71) Applicant: HTC Corporation, Taoyuan City (TW)

(72) Inventor: Yen-Jung LEE, Taoyuan City (TW)

(21) Appl. No.: 19/043,516

(22) Filed: Feb. 2, 2025

(51) Int. Cl. G06T 11/60; G06V 10/10; G06V 10/75; H04N 23/90

(52) U.S. Cl. CPC G06T 11/60; G06V 10/16; G06V 10/751; H04N 23/90; G06V 2201/07

(57) ABSTRACT

An image processing system comprising a first camera, a second camera, and a processor is provided. The first camera is configured to shoot an environment in a first location and in a first orientation to output a main image comprising a target region displaying a target. The second camera is configured to shoot the environment in a second location and in a second orientation to output sub-images. The processor is coupled to the first camera and the second camera, and is configured to match pixels of the main image with pixels of the sub-images. The processor is further configured to collect the pixels of the sub-images corresponding to the pixels of the target region of the main image and not displaying the target, as original background pixels, and replace the pixels of the target region of the main image with the original background pixels to generate a replaced image.

### BACKGROUND

### Technical Field

The present disclosure relates to an image replacement technology. More particularly, the present disclosure relates to an image processing system, an image replacing method and a non-transient computer readable storage medium that can replace a target in an image in real-time.

### Description of Related Art

Image (video) processing technology has experienced significant development in recent years. At present, replacing a human in a video with a virtual character and filling the background can be achieved by using generative AI.

However, since visual effects (VFX) pipelines are used in most of today's image processing technology, it is difficult to reduce costs. In addition, the step of background filling is not fast enough for real-time usage (e.g., live streaming). Therefore, how to perform image processing in real-time and at lower cost is one of the topics in this field.

### SUMMARY

An image processing system is provided in the present disclosure. The image processing system comprises a first camera, a second camera, and a processor. The first camera is configured to shoot an environment in a first location and in a first orientation, so as to output a main image comprising a target region displaying a target. The second camera is configured to shoot the environment in a second location and in a second orientation to output sub-images, wherein the first location is different from the second location, or the first orientation is different from the second orientation. The processor is coupled to the first camera and the second camera, and is configured to match pixels of the main image with pixels of the sub-images. The processor is further configured to collect the pixels of the sub-images corresponding to the pixels of the target region of the main image and not displaying the target, as original background pixels, and replace the pixels of the target region of the main image with the original background pixels to generate a replaced image.

An image replacing method is provided in the present disclosure. The image replacing method comprises: shooting, by a first camera, an environment, in a first location and in a first orientation, so as to output a main image comprising a target region displaying a target to a processor; shooting, by a second camera, the environment, in a second location and in a second orientation, so as to output sub-images to the processor, wherein the first location is different from the second location, or the first orientation is different from the second orientation; matching, by the processor, pixels of the main image with pixels of the sub-images; collecting, by the processor, the pixels of the sub-images corresponding to the pixels of the target region of the main image and not displaying the target, as original background pixels; and replacing, by the processor, the pixels of the target region of the main image with the original background pixels, so as to generate a replaced image.

A non-transient computer readable storage medium storing a plurality of computer readable instructions is provided in the present disclosure. When the plurality of computer readable instructions are executed for replacing a main image outputted by an image processing system, by one or a plurality of processors, the one or the plurality of processors is configured to perform the following operations: shooting an environment in a first location and in a first orientation, so as to output a main image comprising a target region displaying a target; shooting the environment in a second location and in a second orientation, so as to output sub-images, wherein the first location is different from the second location, or the first orientation is different from the second orientation; matching pixels of the main image with pixels of the sub-images; collecting the pixels of the sub-images corresponding to the pixels of the target region of the main image and not displaying the target, as original background pixels; and replacing the pixels of the target region of the main image with the original background pixels, so as to generate a replaced image.

With the image processing system, the image replacing method and the non-transient computer readable storage medium in the present disclosure, image replacement can be performed in real-time without using VFX pipelines, thereby improve the performance of image replacement and lower the costs.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows.

FIG. 1 is a functional block diagram of an image processing system in accordance with some embodiments of the present disclosure.

FIG. 2A is a schematic diagram of an image processing system shooting an environment in accordance with some embodiments of the present disclosure.

FIG. 2B is a schematic diagram of a main image in accordance with some embodiments of the present disclosure.

FIG. 2C is a schematic diagram of the mapping between a sub-image and a main image in accordance with some embodiments of the present disclosure.

FIG. 2D is a schematic diagram of a replaced image in accordance with some embodiments of the present disclosure.

FIG. 2E is a schematic diagram of a replaced image in accordance with some embodiments of the present disclosure.

FIG. 3 is a flowchart of an image replacing method in accordance with some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

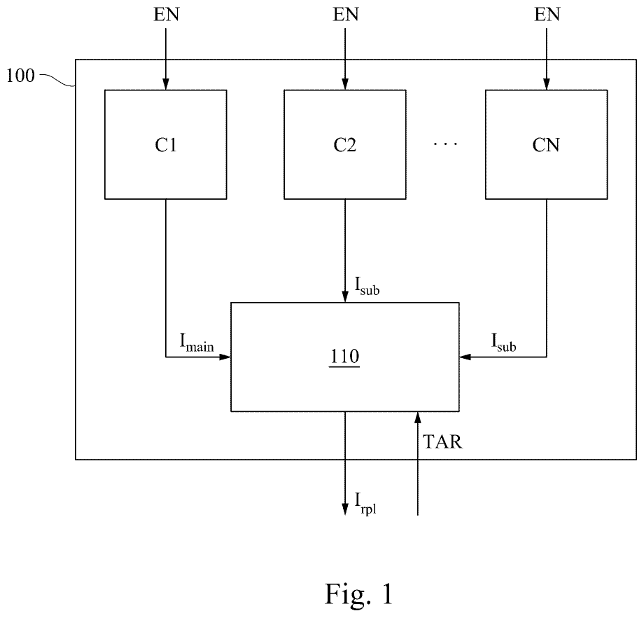

FIG. 1 is a functional block diagram of an image processing system 100 in accordance with some embodiments of the present disclosure. In some embodiments, the image processing system 100 comprises a processor 110 and cameras C1-CN, wherein N is an integer greater than 1. In other words, the image processing system 100 comprises a processor 110 and more than two cameras.

The cameras C1-CN are configured to shoot an environment EN to output images. In some embodiments, one of the cameras C1-CN (e.g., camera C1 in FIG. 1) is configured to act as a first camera (also called as main camera), and the image outputted by the first camera is a main image Iₘₐᵢₙ. The main image Iₘₐᵢₙ is an image that part of which will be replaced in subsequent replacement process (which will be described in following paragraphs). On the other hand, others of the cameras C1-CN (e.g., cameras C2-CN in FIG. 1) are configured to act as sub-cameras (also called as second camera, third camera . . . etc.), and the images outputted by the sub-cameras are sub-images I_{sub} (which includes at least one image captured by the at least one sub-camera, e.g., one or more frames of the sub-images I_{sub} captured by the camera C2, and another one or more frames of the sub-images I_{sub} captured by the camera CN). The sub-images I_{sub} are images which will be used to replace part of the main image Iₘₐᵢₙ in subsequent replacement process.

The processor 110 is coupled to the cameras C1-CN through physical wires or wirelessly. In some embodiments, the processor 110 may be integrated with the main camera (e.g. the camera C1 in FIG. 1).

In some embodiments, the processor 110 is configured to receive the main image Iₘₐᵢₙ and the sub-images I_{sub} from the cameras C1-CN and perform an image replacement based on these images, so as to output a replaced image Iᵣₚₗ. In some embodiments, the processor 110 is further configured to receive a command related to a target TAR that are desired to be removed from the main image Iₘₐᵢₙ, so as to determine a region of the main image Iₘₐᵢₙ that will be replaced in subsequent replacement process.

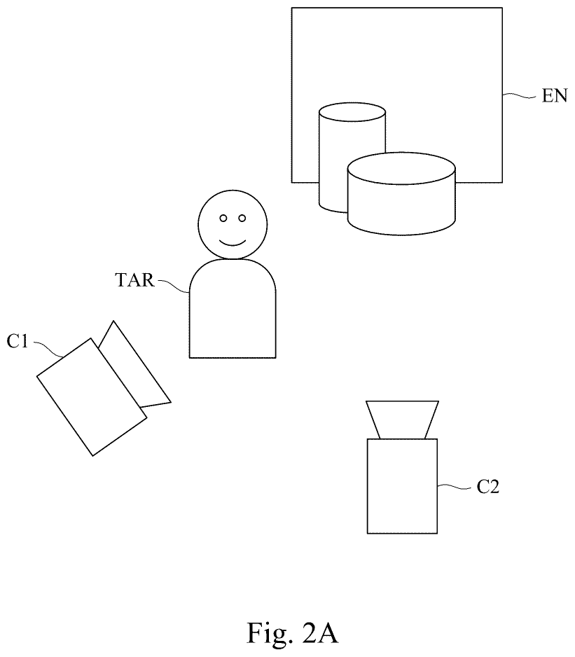

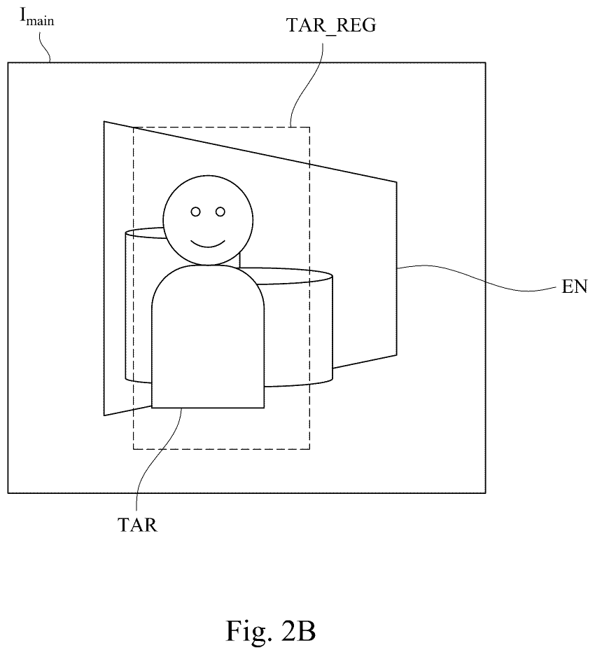

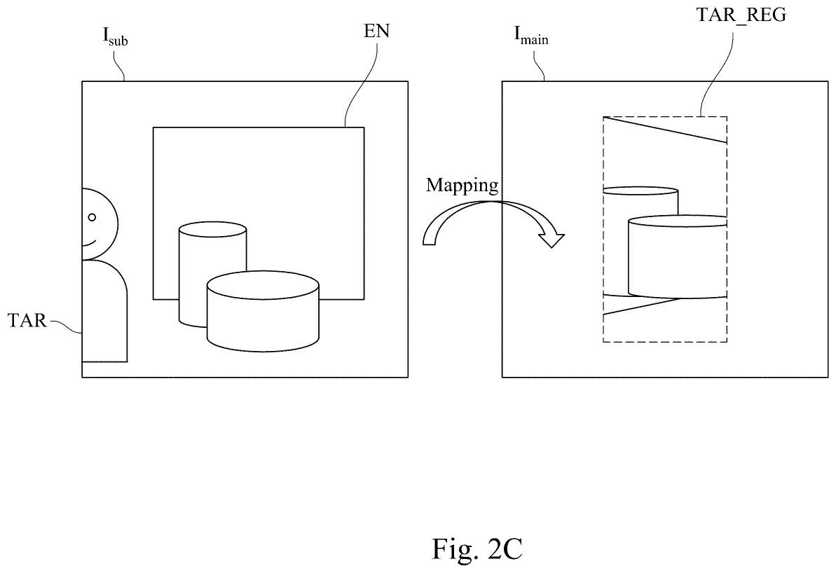

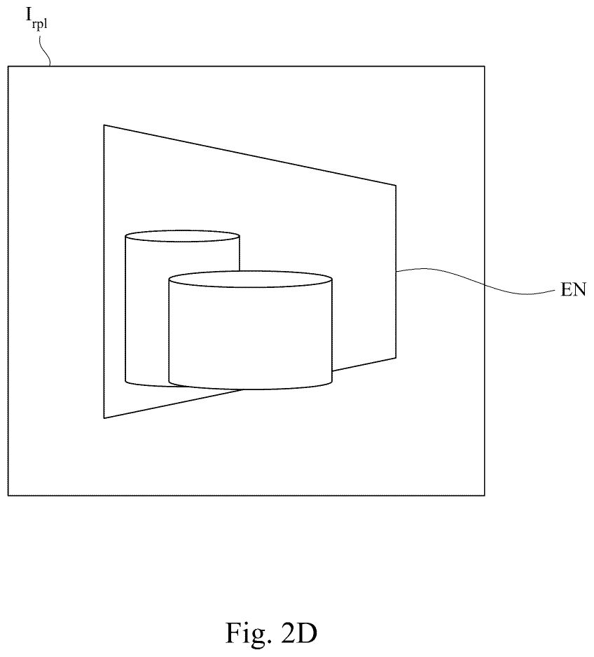

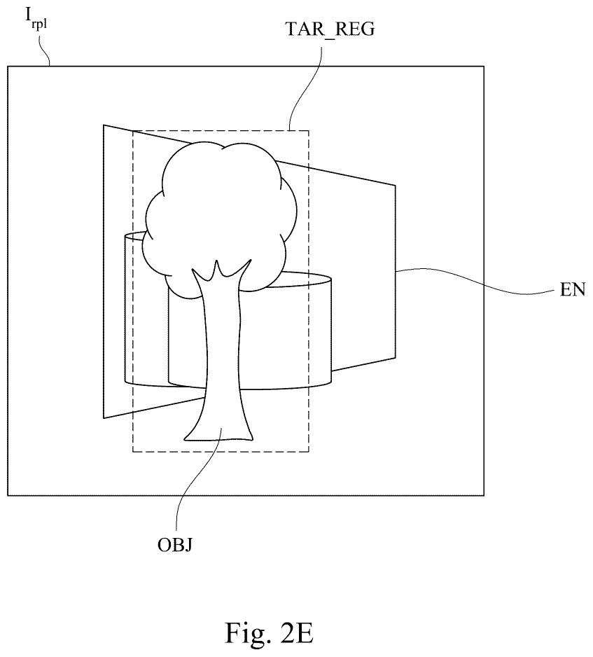

FIGS. 2A-2E are schematic diagrams of the image processing system 100 performing image replacement in accordance with some embodiments of the present disclosure. It should be noted that for the sake of simplicity of figures, only one sub-camera (i.e., camera C2) and one sub-image I_{sub} are shown in FIGS. 2A-2E, but the present disclosure is not limited thereto.

First, please refer to FIG. 2A. FIG. 2A is a schematic diagram of the image processing system 100 shooting the environment EN in accordance with some embodiments of the present disclosure. In the embodiment of FIG. 2A, the first camera C1 is configured to shoot the environment EN in a first location and in a first orientation to output the main image Iₘₐᵢₙ, and the second camera C2 is configured to shoot the environment EN in a second location and in a second orientation to output the sub-image I_{sub}. In some embodiments, the first location is different from the second location, or the first orientation is different from the second orientation (i.e., the first camera C1 is different from the second camera C2).

Next, please refer to FIG. 2B. FIG. 2B is a schematic diagram of the main image Iₘₐᵢₙ in accordance with some embodiments of the present disclosure. In some embodiments, the processor 110 is configured to determine the target TAR that is desired to be removed in the main image Iₘₐᵢₙ, the first camera C1 is configured to identify the target TAR in the environment EN to determine a target region TAR_REG in the main image Iₘₐᵢₙ. Therefore, the main image Iₘₐᵢₙ comprises the environment EN and the target region TAR_REG displaying the target TAR. As mentioned above, the target region TAR_REG is the region that will be replaced the replacement process.

It should be noted that although the target region TAR_REG is illustrated as a rectangle in FIG. 2B, the present disclosure is not limited thereto. In some embodiments, the target region TAR_REG may be of any regular or irregular shape displaying the target TAR.

Next, please refer to FIG. 2C. FIG. 2C is a schematic diagram of the mapping between the sub-image I_{sub} and the main image Iₘₐᵢₙ in accordance with some embodiments of the present disclosure. In some embodiments, the processor 110 is configured to match (i.e., perform mapping between) the pixels of the main image Iₘₐᵢₙ with the pixels of the sub-image I_{sub}. In detail, each of the pixels of the main image Iₘₐᵢₙ and each of the pixels of the sub-image I_{sub} comprises an orientation data and a depth data, and the processor 110 is configured to match the pixels of the main image Iₘₐᵢₙ with the pixels of the sub-image I_{sub} according to the first location of the first camera C1, the second location of the second camera C2, and the orientation data and the depth data of the main image Iₘₐᵢₙ and the sub-image I_{sub}.

When a pixel of the sub-image I_{sub} is corresponding to a pixel of the target region TAR_REG of the main image Iₘₐᵢₙ (through mapping) and does not display the target TAR, the processor 110 is configured to collect this pixel as an original background pixel. Next, the processor 110 will replace the pixels of the target region TAR_REG of the main image Iₘₐᵢₙ with the collected original background pixels, so as to generate a replaced image Iᵣₚₗ.

However, due to the second location and the second orientation of the second camera C2, the amount of the original background pixels may be unable to reach desired amount. Therefore, in some embodiments, when the amount of the original background pixels is less than a target replacement amount (e.g. 80% of the pixels of the target region TAR_REG), the second camera C2 is further configured to move to a third location different from the second location to shoot the environment EN, and/or shoot the environment EN in a third orientation different from the second orientation.

After the second camera C2 changes its shooting location and/or orientation, the processor 110 is configured to match the pixels of the main image Iₘₐᵢₙ with the pixels of the new sub-image I_{sub}, and continue collecting the original background pixels until the amount of the original background pixels reaches the target replacement amount.

In some embodiments, when the amount of the original background pixels is less than the target replacement amount, the processor 110 is further configured to instruct other sub-cameras (e.g., cameras C2-CN in FIG. 1) to shoot the environment EN in various locations and orientations, so as to get various sub-images I_{sub} and collect more original background pixels from these sub-images I_{sub}.

FIG. 2D is a schematic diagram of a replaced image Iᵣₚₗ in accordance with some embodiments of the present disclosure. As shown in FIG. 2D, in some embodiments, after the processor 110 replacing the pixels of the target region TAR_REG of the main image Iₘₐᵢₙ with the collected original background pixels, the target TAR no longer exists in the replaced image Iᵣₚₗ, while the environment EN keeps intact in the replaced image Iᵣₚₗ.

In some embodiments, in addition to removing the target TAR from the main image Iₘₐᵢₙ, the processor 110 is further configured to apply a virtual object in the target region TAR_REG of the replaced image Iᵣₚₗ. In some embodiments, the target TAR is not fully removed from the main image Iₘₐᵢₙ, but the virtual object added by the processor 110 covers the part of the target TAR that is not removed from the main image Iₘₐᵢₙ.

Please refer to FIG. 2E. FIG. 2E is a schematic diagram of the replaced image Iᵣₚₗ in accordance with some embodiments of the present disclosure. In the embodiment of FIG. 2E, the target TAR is removed in the replaced image Iᵣₚₗ, and a virtual object OBJ is applied in the target region TAR_REG of the replaced image Iᵣₚₗ. It should be noted that although the virtual object OBJ is illustrated as a tree in FIG. 2E, the present disclosure is not limited thereto. In some embodiments, the virtual object OBJ may be a creature, an object, a symbol or a combination of the above. In some embodiments, the movements of the virtual object OBJ is related the movements of the target TAR.

In some embodiments, when the target TAR moves or the first camera C1 changes its location and/or orientation (i.e., the target region TAR_REG moves), the processor 110 is configured to instruct the second camera C2 to change its location and/or orientation, so as to make the image processing system 100 achieve real-time characteristic.

In addition, it should be noted that although the camera C1 is configured as the main camera and the cameras C2-CN are configured as the sub-cameras in above paragraphs and figures, the present disclosure is not limited thereto. In some embodiments, any one of the cameras C1-CN can be switched to the main camera, and the others of the cameras C1-CN can be switched to the sub-cameras.

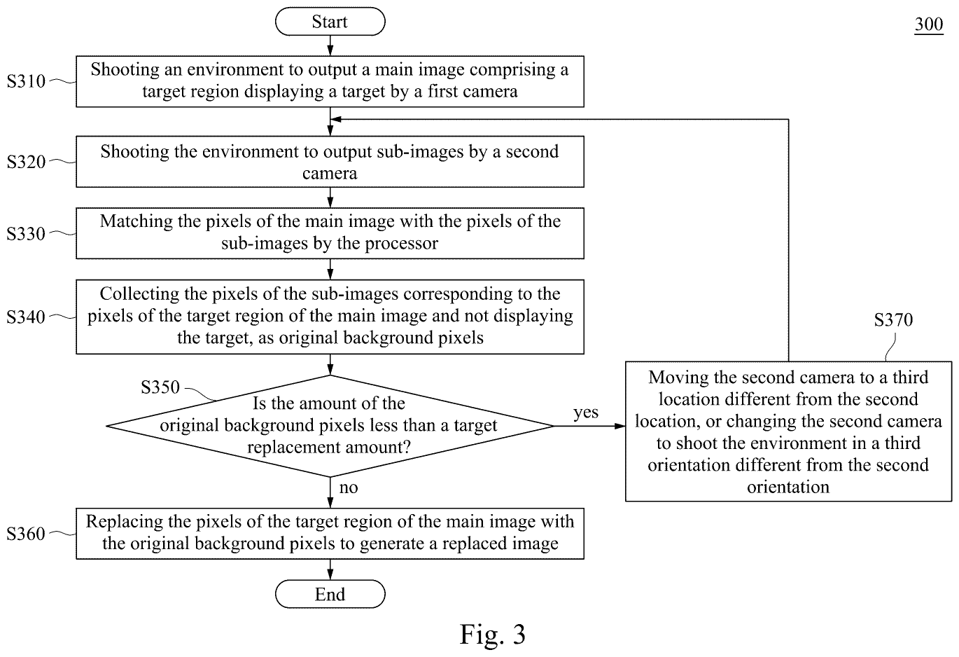

FIG. 3 is a flowchart of an image replacing method 300 in accordance with some embodiments of the present disclosure. In some embodiments, the image replacing method 300 comprises steps S310-S370.

In step S310, a first camera (e.g., the first camera C1) shoots an environment in a first location and in a first orientation, so as to output a main image comprising a target region displaying a target to a processor (e.g., the processor 110). Next, step S320 will be performed.

In step S320, a second camera (e.g., the second camera C2) shoots the environment in a second location and in a second orientation, so as to output sub-images comprising to the processor. Next, step S330 will be performed.

In step S330, the processor matches the pixels of the main image with the pixels of the sub-images. Next, step S340 will be performed.

In step S340, the processor collects the pixels of the sub-images corresponding to the pixels of the target region of the main image and not displaying the target, as original background pixels. Next, step S350 will be performed.

In step S350, the processor determines whether the amount of the original background pixels is less than a target replacement amount, if the amount of the original background pixels is not less than (i.e., equal to or more than) the target replacement amount, step S360 will be performed next; if the amount of the original background pixels is less than the target replacement amount, step S370 will be performed next.

In step S360, the processor replaces the pixels of the target region of the main image with the original background pixels, so as to generate a replaced image.

In step S370, the second camera is moved to a third location different from the second location to shoot the environment, and/or the second camera is changed to shoot the environment in a third orientation different from the second orientation. Next, step S320 will be performed again.

It will be understood that the image replacing method 300 discussed herein may comprise greater or fewer operations than illustrated in FIG. 3, and the steps S310-S370 may be performed in any order or repetitively, as appropriate.

The present disclosure provides a non-transient computer readable storage medium storing a plurality of computer readable instructions, when the plurality of computer readable instructions are executed by one or a plurality of processors, the one or the plurality of processors is configured to perform the steps S310-S370 of the image replacing method 300 described above.

With the image processing system 100, the image replacing method 300 and the non-transient computer readable storage medium in the present disclosure, the image replacement can be performed in real-time, thereby improve the performance and the flexibility of image replacement. In addition, the image processing system 100, the image replacing method 300 and the non-transient computer readable storage medium of the present disclosure can perform image replacements without using VFX pipelines, thereby lowering the total costs.

Certain terms are used in the specification and the claims to refer to specific components. However, those of ordinary skill in the art would understand that the same components may be referred to by different terms. The specification and claims do not use the differences in terms as a way to distinguish components, but the differences in functions of the components are used as a basis for distinguishing. Furthermore, it should be understood that the term “comprising” used in the specification and claims is open-ended, that is, including but not limited to. In addition, “coupling” herein includes any direct and indirect connection means. Therefore, if it is described that the first component is coupled to the second component, it means that the first component can be directly connected to the second component through electrical connection or signal connections including wireless transmission, optical transmission, and the like, or the first component is indirectly electrically or signally connected to the second component through other component(s) or connection means.

It will be understood that, in the description herein and throughout the claims that follow, the phrase “and/or” includes any and all combinations of one or more of the associated listed items. Unless the context clearly dictates otherwise, the singular terms used herein include plural referents.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. An image processing system, comprising:
a first camera, configured to shoot an environment in a first location and in a first orientation, so as to output a main image comprising a target region displaying a target;
a second camera, configured to shoot the environment in a second location and in a second orientation to output sub-images, wherein the first location is different from the second location, or the first orientation is different from the second orientation; and
a processor, coupled to the first camera and the second camera, configured to match pixels of the main image with pixels of the sub-images,
wherein the processor is further configured to collect the pixels of the sub-images corresponding to the pixels of the target region of the main image and not displaying the target, as original background pixels, and replace the pixels of the target region of the main image with the original background pixels to generate a replaced image.

2. The image processing system of claim 1, wherein the processor is further configured to determine the target, and the first camera is further configured to identify the target in the environment to determine the target region of the main image.

3. The image processing system of claim 1, wherein each of the pixels of the main image and each of the pixels of the sub-images comprises an orientation data and a depth data, and the processor is configured to match the pixels of the main image with the pixels of the sub-images according to the first location, the second location, and the orientation data and the depth data of the main image and the sub-images.

4. The image processing system of claim 1, wherein when the amount of the original background pixels is less than a target replacement amount, the second camera is further configured to move to a third location different from the second location to shoot the environment.

5. The image processing system of claim 1, wherein when the amount of the original background pixels is less than a target replacement amount, the second camera is further configured to shoot the environment in a third orientation different from the second orientation.

6. The image processing system of claim 1, wherein the processor is further configured to apply a virtual object in the target region of the replaced image.

7. The image processing system of claim 1, further comprising a third camera configured to shoot the environment in a third location and in a third orientation to output the sub-images,
wherein the processor is coupled to the first camera, the second camera and the third camera, and configured to match the pixels of the main image of the first camera with the pixels of the sub-images of the second camera and the third camera.

8. An image replacing method, comprising:
shooting, by a first camera, an environment, in a first location and in a first orientation, so as to output a main image comprising a target region displaying a target to a processor;
shooting, by a second camera, the environment, in a second location and in a second orientation, so as to output sub-images to the processor, wherein the first location is different from the second location, or the first orientation is different from the second orientation;
matching, by the processor, pixels of the main image with pixels of the sub-images;
collecting, by the processor, the pixels of the sub-images corresponding to the pixels of the target region of the main image and not displaying the target, as original background pixels; and
replacing, by the processor, the pixels of the target region of the main image with the original background pixels, so as to generate a replaced image.

9. The image replacing method of claim 8, wherein shooting, by the first camera, the environment, in the first location and in the first orientation, so as to output the main image comprising the target region displaying the target to the processor comprising:
shooting, by the first camera, the environment;
determining, by the processor, the target;
identifying, by the first camera, the target in the environment; and
determining, by the first camera, the target region of the main image.

10. The image replacing method of claim 8, wherein each of the pixels of the main image and each of the pixels of the sub-images comprises an orientation data and a depth data, and matching, by the processor, the pixels of the main image with the pixels of the sub-images comprises:
matching, by the processor, the pixels of the main image with the pixels of the sub-images according to the first location, the second location, and the orientation data and the depth data of the main image and the sub-images.

11. The image replacing method of claim 8, further comprising:
in response to the amount of the original background pixels being less than a target replacement amount, moving the second camera to a third location different from the second location to shoot the environment.

12. The image replacing method of claim 8, further comprising:
in response to the amount of the original background pixels being less than a target replacement amount, changing the second camera to shoot the environment in a third orientation different from the second orientation.

13. The image replacing method of claim 8, further comprising:
applying, by the processor, a virtual object in the target region of the replaced image.

14. The image replacing method of claim 8, further comprising
shooting, by a third camera, the environment, in a third location and in a third orientation; and
outputting, by the third camera, the sub-images to the processor.

15. A non-transient computer readable storage medium, storing a plurality of computer readable instructions, when the plurality of computer readable instructions are executed for replacing a main image outputted by an image processing system, by one or a plurality of processors, the one or the plurality of processors is configured to perform the following operations:
shooting an environment in a first location and in a first orientation, so as to output a main image comprising a target region displaying a target;
shooting the environment in a second location and in a second orientation, so as to output sub-images, wherein the first location is different from the second location, or the first orientation is different from the second orientation;
matching pixels of the main image with pixels of the sub-images;
collecting the pixels of the sub-images corresponding to the pixels of the target region of the main image and not displaying the target, as original background pixels; and
replacing the pixels of the target region of the main image with the original background pixels, so as to generate a replaced image.

16. The non-transient computer readable storage medium of claim 15, wherein the operation of shooting the environment in the first location and in the first orientation, so as to output the main image comprising the target region displaying the target comprises:
shooting the environment;
determining the target;
identifying the target in the environment; and
determining the target region of the main image.

17. The non-transient computer readable storage medium of claim 15, wherein each of the pixels of the main image and each of the pixels of the sub-images comprises an orientation data and a depth data, and the operation of matching the pixels of the main image with the pixels of the sub-images comprises:
matching the pixels of the main image with the pixels of the sub-images according to the first location, the second location, and the orientation data and the depth data of the main image and the sub-images.

18. The non-transient computer readable storage medium of claim 15, wherein the one or the plurality of processors is further configured to perform the following operation:
in response to the amount of the original background pixels being less than a target replacement amount, shooting the environment in a third location different from the second location to output the sub-images.

19. The non-transient computer readable storage medium of claim 15, wherein the one or the plurality of processors is further configured to perform the following operation:
in response to the amount of the original background pixels being less than a target replacement amount, shooting the environment in a third orientation different from the second orientation to output the sub-images.

20. The non-transient computer readable storage medium of claim 15, wherein the one or the plurality of processors is further configured to perform the following operation:
applying a virtual object in the target region of the replaced image.
